(19) United States
(12) Patent Application Publication
(10) Pub. No.: US 2017/0197457 A1
(43) Pub. Date: Jul. 13, 2017

(54) CONDUIT TOOL

(71) Applicants: Daniel Garr, Los Angeles, CA (US); Ramon Dawson, Long Beach, CA (US)

(72) Inventors: Daniel Garr, Los Angeles, CA (US); Ramon Dawson, Long Beach, CA (US)

(21) Appl. No.: 14/991,859

(22) Filed: Jan. 8, 2016

(51) Int. Cl. B44B 3/04; B44B 3/00; B41F 17/30; B23B 5/16

(52) U.S. Cl. CPC B44B 3/04; B23B 5/16; B44B 3/006; B41F 17/30

(57) ABSTRACT

According to various embodiments, there is provided a conduit reamer component including: a conical body having a first end for receiving a conduit and a second end opposite the first end, the conduit body including a first circumferential ledge having a first diameter and located in the conical body, and a second circumferential ledge having a second diameter smaller than the first diameter and located in the conical body, the first circumferential ledge located between the second circumferential ledge and the first end of the conical body.

### BACKGROUND

1. Field

The disclosure relates generally to a tool for use with conduits and, in particular embodiments, to a tool and components thereof, for one or both of reaming (or deburring) and marking conduits.

2. Background

Conduits, such as pipes, are commonly cut with saw blades to various desired lengths. Saw blades, however, may leave burs or otherwise rough edges on ends of the conduits after cutting. Conduit reamers are typically used to ream or deburr the ends of these conduits in order to clean and smooth the ends. Conventional conduit reamers extend outwards such that the reaming tool extends into the pipe as the reamer deburrs the ends. These conduit reamers may be bulky and require extra material for manufacturing. Furthermore, conduits are frequently bent into a desired shape. Current techniques of bending a conduit may frequently result in “dog-legging,” which occurs when bends on a single piece of conduit are misaligned, sometimes resulting in disposal and waste of the misaligned conduit.

### SUMMARY

Embodiments of the present disclosure relate to a tool (or a component of a tool) that provides a pipe deburring function. Further embodiments relate to a tool that provides one or more (or a variety) of functions related to conduits while maintaining compactness and effectiveness of the components of the tool, including one or more of deburring, marking and level checking. Further embodiments relate to a tool that provides a plurality of such functions.

According to various embodiments, a conduit reamer tool or tool component includes: a conical body having a first end for receiving a conduit and a second end opposite the first end, the conduit body including a first circumferential ledge having a first diameter and located in the conical body, and a second circumferential ledge having a second diameter smaller than the first diameter and located in the conical body, the first circumferential ledge located between the second circumferential ledge and the first end of the conical body.

In some embodiments, the first end of the conical body has a larger diameter than that of the second end of the conical body.

In some embodiments, the conduit reamer further includes a slit in the conical body extending longitudinally between the first end and the second end, and a blade located in the slit and comprising a plurality of slots, each slot located at different distances from a center of the conical body.

In some embodiments, the slit crosses the first and second circumferential ledge.

In some embodiments, each slot of the blade is configured to receive a conduit having a different diameter.

In some embodiments, the blade includes a first slot corresponding to the first diameter of the first circumferential ledge and a second slot corresponding to the second diameter of the second circumferential ledge.

In some embodiments, the first circumferential ledge is configured to abut an edge of a conduit having the first diameter and the second circumferential ledge is configured to abut an edge of a conduit having the second diameter.

In some embodiments, the conical body further includes a third circumferential ledge having a third diameter smaller than the second diameter and located in the conical body, the first and second circumferential ledges located between the third circumferential ledge and the first end of the conical body.

In some embodiments, the third circumferential ledge is configured to abut an edge of a conduit having the third diameter.

In some embodiments, the conical body is configured to receive the conduit in a first direction, and the conical body extends in the first direction.

According to various embodiments, there is provided a method of manufacturing a conduit reamer component, the method including: providing a conical body having a first end for receiving a conduit and a second end opposite the first end, molding a first circumferential ledge having a first diameter and located in the conical body, and molding a second circumferential ledge having a second diameter smaller than the first diameter and located in the conical body, the first circumferential ledge located between the second circumferential ledge and the first end of the conical body.

In some embodiments, the method further includes: forming a slit in the conical body extending longitudinally between the first end and the second end, and providing a blade located in the slit and comprising a plurality of slots, each slot located at different distances from a center of the conical body.

In some embodiments, the slit crosses the first and second circumferential ledge.

In some embodiments, the blade includes a first slot corresponding to the first diameter of the first circumferential ledge and a second slot corresponding to the second diameter of the second circumferential ledge.

In some embodiments, the conical body further includes a third circumferential ledge having a third diameter smaller than the second diameter and located in the conical body, the first and second circumferential ledges located between the third circumferential ledge and the first end of the conical body.

According to various embodiments, a tool for receiving and marking a conduit includes: a plurality of rollers configured to contact a conduit a 90-degree intervals along a circumference of the conduit, each of the rollers configured to etch a length of the conduit.

In some embodiments, the plurality of rollers includes: a first roller configured to etch a length of a conduit along a first linear path along the length of the conduit, and a second roller configured to etch the length of the conduit along a second linear path along the length of the conduit, the second linear path being spaced 90 degrees from the first linear path along a circumference of the conduit.

In some embodiments, the plurality of rollers further includes a third roller configured to etch the length of the conduit along a third linear path along the length of the conduit, the third linear path being spaced 90 degrees from the second linear path along the circumference of the conduit.

In some embodiments, each of the plurality of rollers is configured to contact the conduit simultaneously when the conduit is tilted at a first angle within the tool, and wherein each of the plurality of rollers is further configured to contact a second conduit, having a size different from that of the conduit, simultaneously when the second conduit is tilted at a second angle different from the first angle within the tool.

In some embodiments, the tool further comprises a cavity for storing a plurality of pieces of lead, each of the pieces of lead to be used with a lead ejector component in the tool.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a perspective view of a conduit reamer component according to various embodiments;

FIG. 1B is a top view of the conduit reamer component according to various embodiments;

FIG. 2A is a perspective view of a tool including a conduit reamer component according to various embodiments;

FIG. 2B is an exploded perspective view of the tool including the conduit reamer component according to various embodiments;

FIG. 3 is a side view of a blade of a conduit reamer component according to various embodiments;

FIGS. 4A and 4B are rear perspective views of a tool including a plurality of rollers according to various embodiments;

FIG. 4C is a front perspective view of a tool according to various embodiments; and

FIG. 5 is a front view of a tool including a plurality of rollers surrounding a conduit according to various embodiments.

FIG. 6 is a cross-sectional overhead view of a tool including a plurality of rollers surrounding various sized conduits according to various embodiments.

The features of embodiments will become more apparent from the detailed description set forth below when taken in conjunction with the drawings, in which like reference characters identify corresponding elements throughout. In the drawings, like reference numbers generally indicate identical, functionally similar, or structurally similar elements.

### DETAILED DESCRIPTION

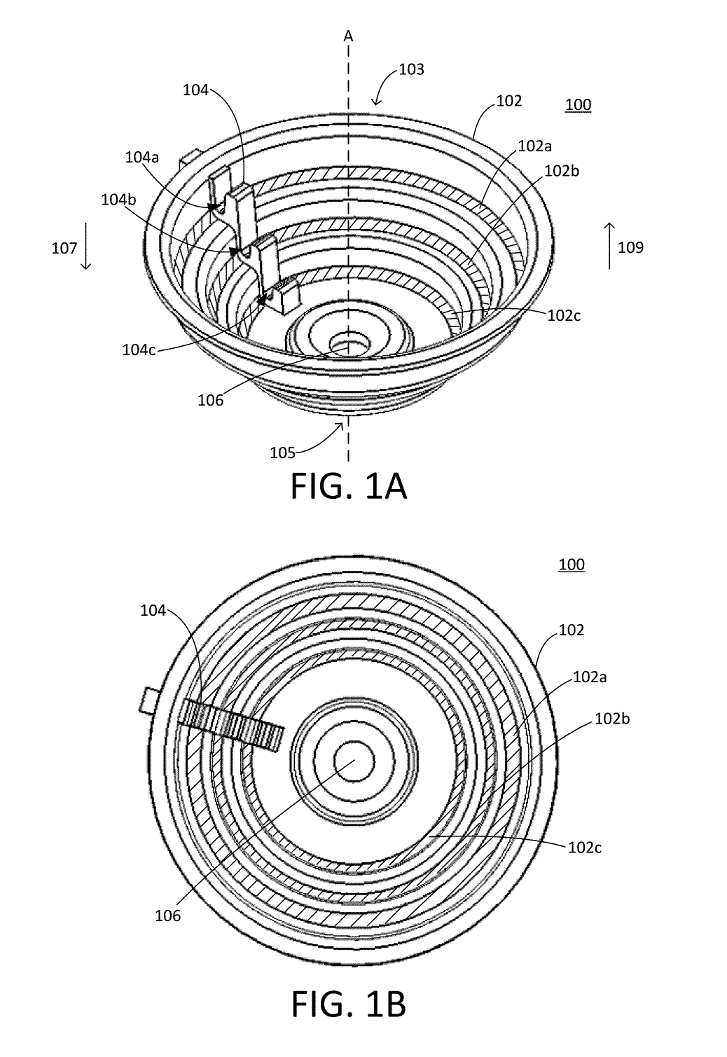

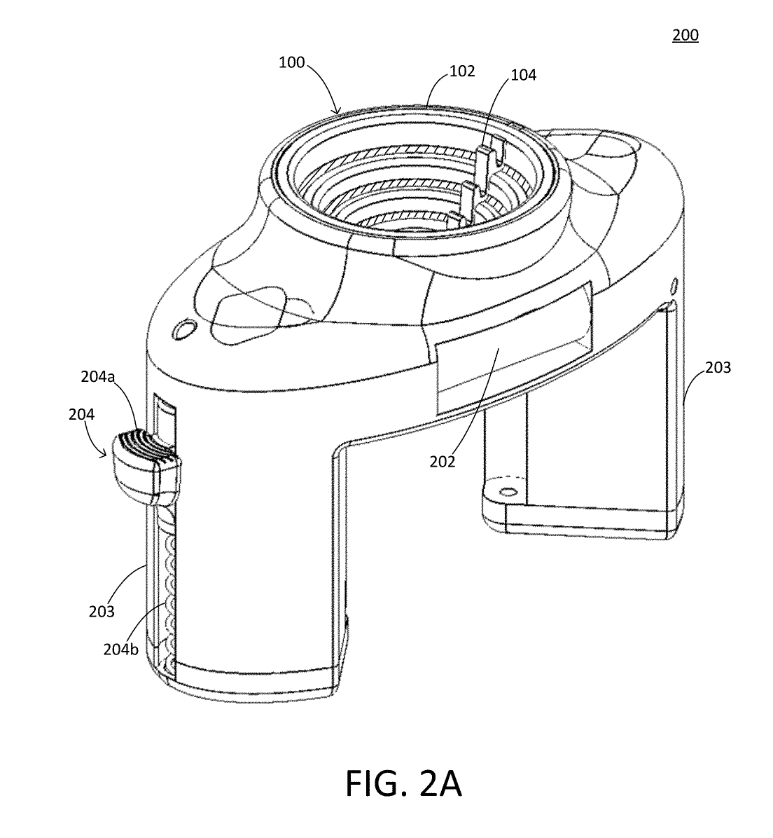

FIG. 1A is a perspective view of a conduit reamer component 100 according to various embodiments. FIG. 1B is a top view of the conduit reamer component 100 according to various embodiments. In particular embodiments, the conduit reamer component 100 may, itself, be configured as a tool for reaming (or deburring) a conduit. In other embodiments, the conduit reamer component 100 may be incorporated into a handle to provide a dedicated conduit reaming (or deburring) tool, or in the handle of another tool, to provide an additional conduit reaming (or deburring) function to the tool. In yet other embodiments, the conduit reamer component 100 may be provided in a multi-purpose tool, where the tool may include features that provide additional functions.

Referring to FIGS. 1A and 1B, in some embodiments, the conduit reamer tool or tool component 100 includes a conical body 102 and a blade 104. The conical body 102 has a first end 103 and a second end 105, where the first end 103 has a larger diameter cross-section than the second end 105 (where such cross sections are taken perpendicular to a central axis A of the conical shape of the conical body 102). The diameter of the conical body 102 may steadily decrease in circumference from the first end 103 to the second end 105 along the first direction 107. In other embodiments, the body 102 may take any suitable shape, such as, but not limited to, a square or other rectangular body, a cylindrical body, and/or the like. For example, the conical body 102 may have an increased or decreased height (from the first end 103 to the second end 105) relative to the illustrated embodiment, for accommodating a greater or smaller number of circumferential ledges. Furthermore, the height of the conical body 102 may be increased, to aid in the stability of the conduit being reamed. The conical body 102 may be made from any suitable rigid material, such as, but not limited to, brass, steel, plastic, polyvinyl chloride (PVC), nylon, galvanized steel, and/or the like.

The conical body 102 includes a plurality of circumferential ledges 102a, 102b, and 102c around the circumferences of the conical body 102. The conical body 102 is open at the first end 103 to the conical interior of the conical body. In certain embodiments, the conical body 102 includes a center hole 106 at the second end 105, while in other embodiments the center hole 106 may be omitted (such that the second end 105 is closed). The blade 104 may include a plurality of slots 104a, 104b, and 104c. While the conical body 102 in the illustrated embodiment has three circumferential ledges, and the blade 104 in the illustrated embodiment has three slots, other embodiments may include one, two or more than three circumferential ledges and (or) blades.

In some embodiments, an end of a conduit may be inserted into the interior of the conical body 102 (in a first direction 107, along the central axis A of the conical shape of the conical body 102), through the open first end 103 of the conical body 102, for a deburring operation. In addition, the end of the conduit may be removed from the conical body 102, by moving the conduit (along the central axis A of the conical shape, in the second direction) out of the interior of the conical body 102, through the open first end 103, after deburring.

In some embodiments, each of the circumferential ledges 102a-102c is located along an inner circumference of the conical body 102, each at a different distance from the open first end 103 of the conical body 102. For example, the first circumferential ledge 102a may be located closest to the first end 103, the second circumferential ledge 102b may be located at a distance from the first end 103 greater than the distance between the first circumferential ledge 102a and the first end 103. The third circumferential ledge 102c may be located at a distance from the first end 103 greater than the distance between the second circumferential ledge 102b and the first end 103. In other words, the circumferential ledges 102a-102c may be located along the inner surface of the conical body 102 and spaced apart from each other. In some embodiments, the circumferential ledges 102a-102c are spaced apart from each other along the length of the conical body 102 at equal spacing distances. In other embodiments, the circumferential ledges 102a-102c are spaced from each other at varying distances (e.g., the distance between the second circumferential ledge 102b and the first circumferential ledge 102a is different from the distance between the second circumferential ledge 102b and the third circumferential ledge 102c). In particular embodiments, the spacing between circumferential ledges and the angle of the conical shape of the conical body (relative to the central axis A of the conical shape) is selected such that the outer diameter of each circumferential ledge 102a-102c corresponds to (is equal to, or slightly larger than) the outer diameter of a conventional conduit size. Accordingly, to initiate a deburring operation, an end of a conduit of a conventional conduit size may be inserted into the open first end 103 of the conical body 102 and moved inward to abut against one of the ledges 102a-102c (the ledge that has an outer diameter corresponding to the outer diameter of the conduit).

Because the conical body 102 narrows in circumference or diameter along its length, and because each of the circumferential ledges 102a-102c is located at increasing depths within the conical body 102, the circumferential ledges 102a-102c may have decreasing circumferences or diameters the deeper the circumferential ledges 102a-102c are located within the conical body and from the first end of the conical body 102. For example, the first circumferential ledge 102a may have a circumference or diameter greater than those of the second circumferential ledge 102b and the third circumferential ledge 102c, the second circumferential ledge 102b may have a circumference or diameter greater than that of the third circumferential ledge 102c and less than that of the first circumferential ledge 102a, and the third circumferential ledge 102c may have a circumference or diameter smaller than those of the first circumferential ledge 102a and the second circumferential ledge 102b. As such, conduits of varying outer diameters or circumferences may be inserted into the conical body 102 and contact or abut one of the circumferential ledges 102a-102c that correspond in outer circumference or diameter to that of the conduit.

In some embodiments, the size and diameters of the three circumferential ledges 102a-102c may correspond in circumference or diameter to conduits of any suitable size, such as, but not limited to, ½″ (102c), ¾″ (102b), and 1″ (102a) diameter conduits. In other embodiments, other suitable ledge size and diameters may be employed, to correspond to other suitable conduit diameters. In particular embodiments, the ledge size and diameters are selected to correspond to at least one (or a plurality) of conventional conduit diameters and sizes. In further embodiments, one or more (or each) of the circumferential ledges 102a-102c may be configured to contact and abut conduits having a range of outer diameters.

The blade 104 may be configured to ream or deburr conduits (e.g., pipes, tubes, etc.) of various diameters. In some embodiments, the blade 104 may be positioned within a slot-shaped slit (not shown) through the conical-shaped wall of the conical body 102. The slit may be formed along the length of the conical body 102 and may extend long a portion or the entire length of the conduit body 102 through the inner and outer surfaces of the conical body 102. The blade 104 may be secured at the conical body 102 by any suitable fastening means, such as, but not limited to one or more, screws, adhesives, rivets, welds, and/or the like. In other embodiments, the blade 104 may be integrally formed in the conduit body 102. In some embodiments, the blade 104 may be removable from the conical body 102, for replacement or servicing. The blade 104 may be made from any suitable rigid material that can deburr a conduit, such as, but not limited to, steel, other metal, high strength plastic, ceramic, metal material that is metallurgically heated to any workable temperature to increase strength (e.g., Rockwell standards), annealed metal, diamond, and/or the like.

In some embodiments, the blade 104 includes a plurality of slots 104a-104c, with each of the slots 104a-104c corresponding to a respective circumferential ledge 102a-102c. For example, the first slot 104a may be located at the first circumferential ledge 102a such that both the first slot 104a and the circumferential ledge 102a are located at a same diameter or distance from the center axis A of the conical body 102. Similarly, the second slot 104b may correspond to the location of the second circumferential ledge 102b and the third slot 104c may correspond to the location of the third circumferential ledge 102c. Accordingly, each of the slots 104a-104c may receive and maintain an edge of a conduit inserted into the conical body 102 for reaming or deburring of the conduit. In other embodiments, the blade 104 may include as many slots as there are circumferential ledges for reaming a conduit of various diameters. In other embodiments, the blade 104 includes more or less slots as there are circumferential ledges.

In operation, the illustrated conduit reamer component 100 is configured to ream conduits having three different diameters. For example, the first slot 104a of the blade 104 can ream an electrical metal tube (EMT) having a 1 inch inside diameter, the second slot 104b of the blade 104 can ream an EMT having a ¾ inch inside diameter, and the third slot 104c can ream an EMT having a ½ inch inside diameter. An end of a conduit may be inserted into the conical body 102 until the end of the conduit contacts the corresponding slot 104a-104c at the corresponding circumferential ledge 102a-102c. The conduit reamer component 100 (or the inserted conduit) may then be rotated along the central axis of the conduit that extends along the length of the conduit (i.e., central axis A that extends through the center hole 106 of the conduit reamer component 100) to ream and deburr the end of the conduit. In such embodiments, due to the inverted body and shape of the conduit reamer component 100, the shavings and excess materials ejected from the conduit during the reaming process may land into the conical body 102 for ease of disposal. In other embodiments, the circumferential ledges 102a-102c and associated slots 104a-104c of the blade 104 may be configured to ream and smooth conduits having other diameter dimensions than those shown and described (e.g., ¼ inch, 1½ inch, and so on). In further embodiments, the conduit reamer component 100 includes fewer or more circumferential ledges and associated blade slots than shown and described.

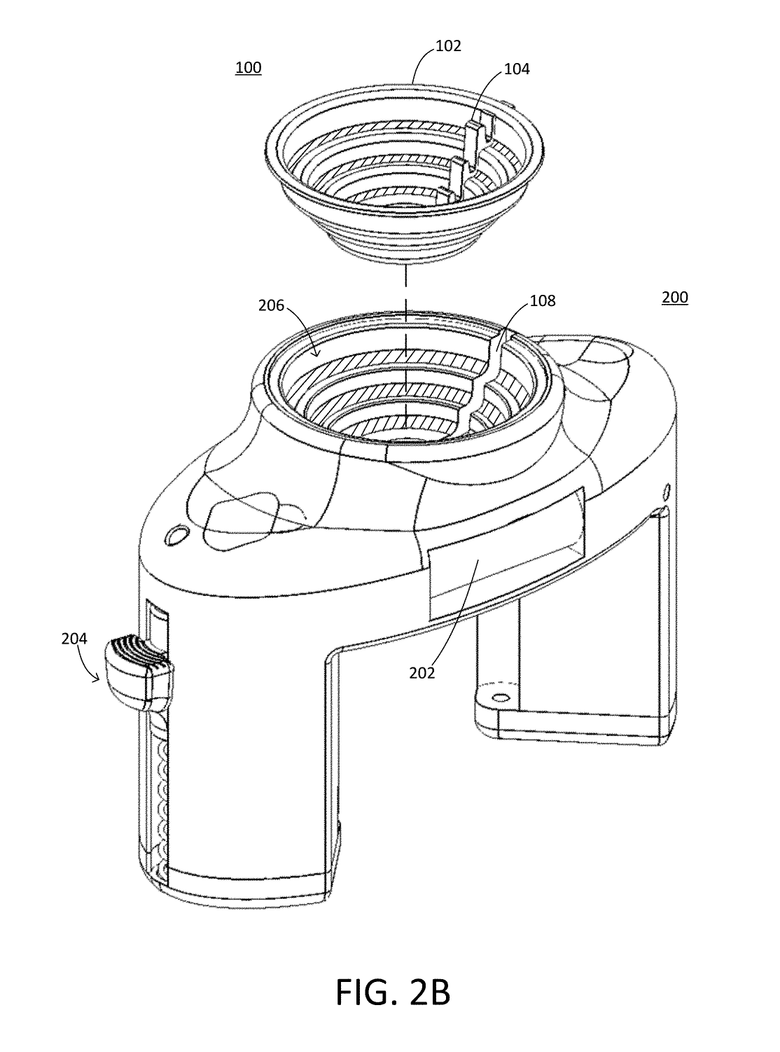

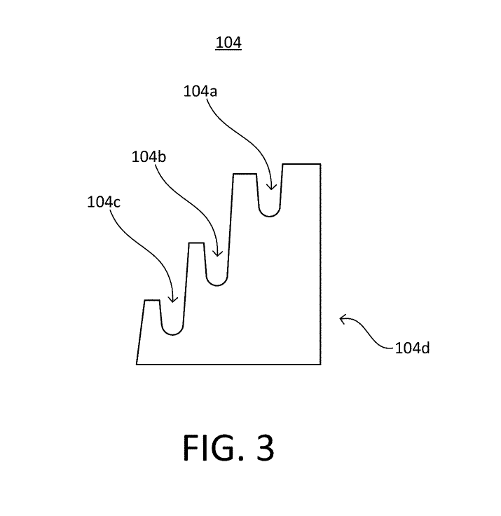

In particular embodiments, the conduit reamer component 100 may be configured, itself, as a tool for reaming (or deburring) conduit. In other embodiments, the conduit reamer component 100 may be incorporated into a handle or other feature of another tool, such as, but not limited to a screw driver, hammer, wrench, plyer, power tool, or the like. In yet other embodiments, the conduit reamer component 100 may be incorporated in a conduit scoring or marking tool. In yet other embodiments, the conduit reamer component 100 may be incorporated in a multiple-purpose tool configured to provide a plurality of functions. FIG. 2A is a perspective view and FIG. 2B is an exploded perspective view of an example of a multiple purpose tool 200 that includes the conduit reamer component 100 according to various embodiments. Features described with respect to the embodiments of FIGS. 2A and 2B can be employed in other embodiments including, but not limited to, embodiments described with respect to FIGS. 1A and 1B. The same reference numbers as employed in previously described embodiments are used for corresponding features of the embodiments of FIGS. 2A and 2B.

The tool 200 may be configured to provide one or more (or multiple) functions with respect to conduits. The tool 200 includes a main body 201 and a plurality of legs 203. The tool 200 in the illustrated embodiment has two legs 203. Other embodiments may have one or more than two legs. The tool 200 may include the conduit reamer component 100 at a top portion of the main body 201. The legs 203 may be provided at an end or side (e.g., a bottom end or side) of the tool 200 opposite from the end or side of the tool at which the conduit reaming component 100 is located. Accordingly, during operation of the conduit reaming component 100, a user may apply rotational force and leverage to the conduit reaming component 100, by gripping and manually the legs 203 and manually rotating the tool 200.

In some embodiments, the tool 200 may include a horizontal level 202. The horizontal level 202 may provide a user with a visual cue as to whether a surface on which the tool 200 sits (e.g., via the legs 203) is sufficiently level or not. In some embodiments, the horizontal level 202 may include liquid and an air bubble within the liquid, with the air bubble indicating the degree of level of a surface. In such embodiments, the legs 203 provide a sturdy and level base for positioning the tool 200 on a surface for accurately reading a level of the surface.

In some embodiments, the tool 200 may include a lead ejector 204. The lead ejector 204 may include an actuator 204a and a spring 204b. The lead ejector 204 may be configured to eject a piece of lead that is housed within the tool 200 (e.g., within one of the legs 203). In operation, a user may apply a downward force to the actuator 204a to compress the spring 204b. Upon compression of the spring, the piece of lead may be ejected out of the tool 200 (e.g., out of a hole at a bottom of one of the legs 203) for use by a user. The amount of lead exposed outside of the tool 200 may depend on the amount of downward force applied to the actuator 203a. Upon releasing the actuator 203a after applying the downward force, the lead may retract back into the tool 200.

In some embodiments, the tool 200 may house within a cavity, a plurality of pieces of lead for storing and replacing a used piece of lead. In some embodiments, a piece of lead may be coupled or attached to the portion of the actuator 204a (inside of the tool 200) configured to receive the piece of lead (e.g., a cone-shaped structure configured to receive lead of various diameters). The piece of lead may be coupled and secured to the portion of the actuator 204a that receives the lead in any suitable manner for securing the piece of lead, such as, but not limited to, friction fitting, adhesive, and/or the like. As such, the lead ejector 204 provides a user with a compact and effective component for marking various objects (e.g., conduits) or writing notations (or both).

In some embodiments, the tool 200 may include a cavity 206 at the top portion of the tool 200 for receiving the conduit reamer component 100. The cavity 206 may have a shape that corresponds to the shape of the conical body 102 such that the conical body 102 fits inside the cavity 206 (e.g., the conical body 102 is flush with the cavity 206 when the conical body 102 is positioned within the cavity 206). The cavity 206 may further have a slit 108 along the height of the cavity 206. The slit 108 may be an empty space for receiving the blade 104 of the conduit reamer component 100. For example, the slit 108 may substantially conform to the shape of the end of the blade 104 that will be positioned within the slit 108 (e.g., the slit may have a triangular cavity for receiving a triangular end of the blade 104). In some embodiments, the conical body 100 also includes a slit similar to slit 108 for allowing the slots 104a-104c of the blade 104 to protrude above the conical body 102 such that each of the slots 104a-104c correspond in location to respective circumferential ledges 102a-102c of the conical body 102.

Although the conduit reamer component 100 is illustrated as a part of the tool 200, the conduit reamer component 100 may be manufactured as a part of any other tool or piece of equipment. For example, the conduit reamer 100 may be configured as a portion of a screwdriver, a drill, a portable hand saw, and/or the like. Given its compact design, the conduit reamer component 100 may be permanently or detachably configured to be a portion of any tool having an accommodating space (e.g., any tool that includes a handle such that the conduit reamer component 100 may be integrated into the handle, for example, the an end of the handle). In some embodiments, the conduit reamer component 100 may be automated such that a user need not exert manual rotational force to deburr a conduit. For example, the conduit reamer component 100 may be a detachable drill bit for inserting into a power drill. In some embodiments, the conduit reamer component 100 may be a standalone tool.

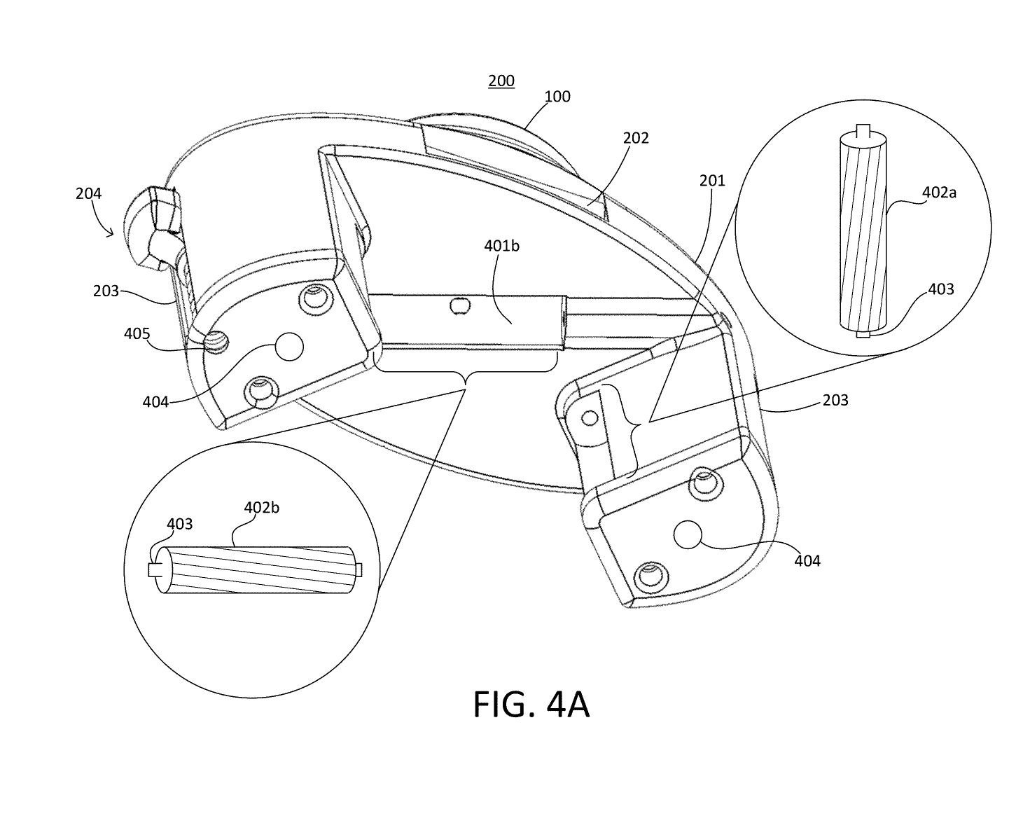

FIG. 3 is a side view of a blade 104 of a conduit reamer component 100 according to various embodiments. Features described with respect to the embodiment of FIG. 3 can be employed in other embodiments including, but not limited to, embodiments described with respect to FIGS. 1A-2B. Same reference numbers as those previously illustrated and introduced may correspond to the depiction and description of those reference numbers previously illustrated and previously described.

Referring to FIGS. 1A-3, the blade 104 includes the plurality of slots 104a-104c, each of the slots 104a-104c corresponding to one of the circumferential ledges 102a-102c. In other embodiments, the blade 104 may include any other suitable number of slots for receiving various sizes of conduits (e.g., one, two, four, or more). The blade 104 may further include an edge 104d. The edge 104d may be the portion of the blade 104 that is received by the slit 108 in the cavity 206 of the tool 200. In addition, the edge 104d may be the portion of the blade 104 that is received by the slit in the conical body 102.

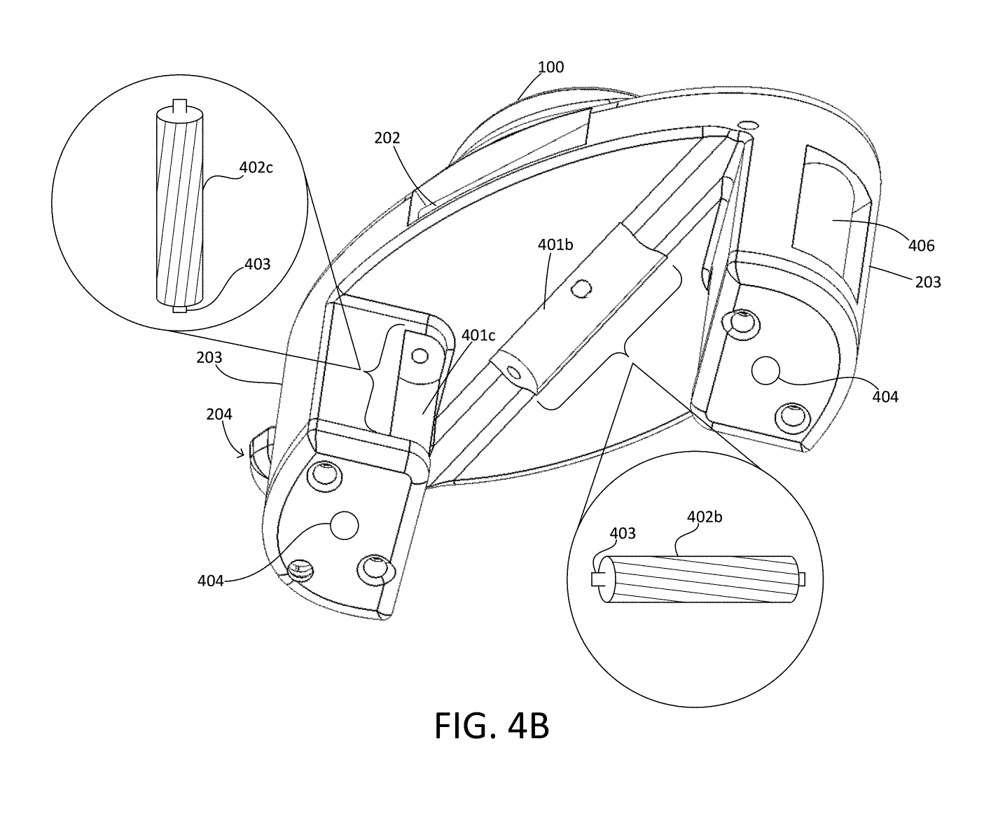

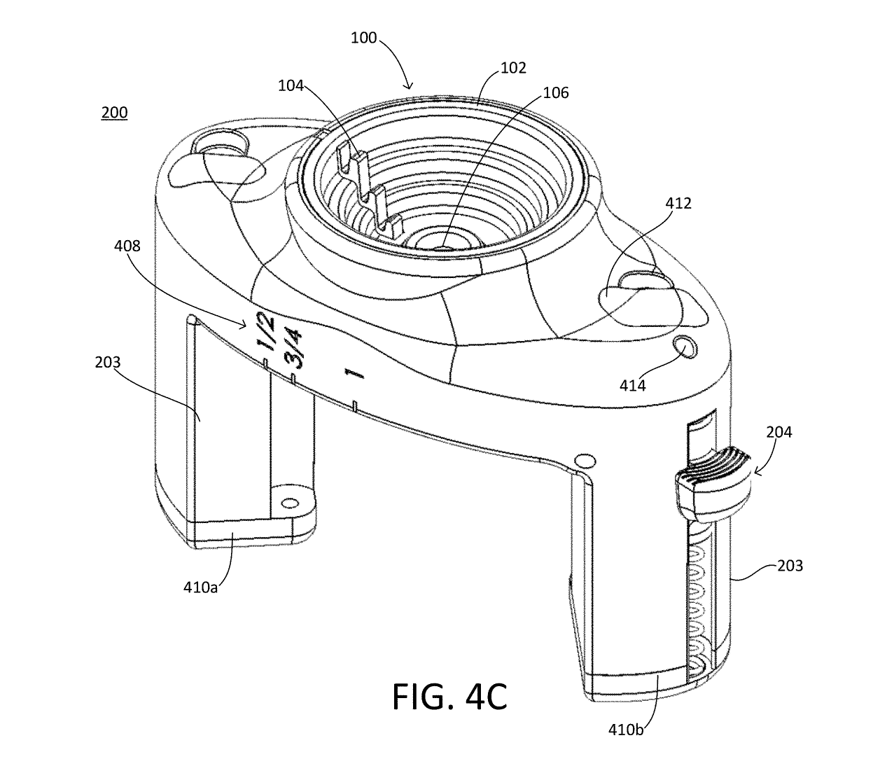

FIGS. 4A and 4B are rear perspective views of the tool 200 including a plurality of rollers according to various embodiments. FIG. 4C is a front perspective view of a tool according to various embodiments. Features described with respect to the embodiments of FIGS. 4A-4C can be employed in other embodiments including, but not limited to, embodiments described with respect to FIGS. 1A-3. Same reference numbers as those previously illustrated and introduced may correspond to the depiction and description of those reference numbers previously illustrated and previously described.

Referring to FIGS. 1A-4C, the tool 200 includes a plurality of chambers 401a-401c. Each of the chambers 401a-401c may be configured to house a respective hob or roller 402a-402c. For example, the chamber 401a may house a vertical roller 402a, the chamber 401b may house a horizontal roller 402b, and the chamber 401c may house a vertical roller 402c. Each of the rollers 402a-402c may be a cylindrical structure including an axel 403 along the cylinder's center axis such that the roller is capable of rotating about its center axis (e.g., about the axel 203 located through its center axis). Accordingly, the rollers 402a-402c are configured to rotate along their center longitudinal axis while being secured and housed within the chambers 401a-401c.

In some embodiments, the rollers 402a-402c are configured to have a shape that includes a plurality of protruding blades or knurls such that each roller is capable of etching (i.e., causing an imprint or mark) when the roller is rolled along a length of a conduit, the etching being caused by the knurls. For example, the rollers 402a-402c may each have a plurality of helical knurls jutting outwards. In other embodiments, the knurls of the rollers 402a-402c may be any other suitable pattern for etching a conduit, such as, but not limited to, straight lines, a plurality of shapes (e.g., triangles, stars, etc.), and/or the like. In some embodiments, the knurls of the rollers 402a-402c are configured to imprint or etch markings along a length of a conduit at intervals according to the pattern of the knurls.

In some embodiments, the top roller 402b may be positioned diagonally across underside of the main body 201 of the tool 200, as illustrated in FIGS. 4A and 4B. In addition, the side rollers 402a and 402c may be positioned at staggered positions, with one of the side rollers being in front of the other side roller. In other words, when the tool 200 is observed directly from the side (e.g., directly from the location of the lead ejector 204), the side roller 402c may be at a position that is behind the side roller 402a, and the top roller 402b may span across the underside of the main body 201 at a slant or diagonal. Accordingly, in such embodiments, a conduit that is received by the tool 200 underneath the main body 201, may be pivoted such that each of the rollers 402a-402c contacts the conduit simultaneously. In other words, a conduit that is received by the tool 200 underneath the main body 201, may be pivoted by a user such that the length of the conduit is perpendicular to the diagonal top roller 402b and such that each of the staggered side rollers 402a and 402c contact the conduit simultaneously, which may optimize the etching performance of all the roller 402a-402c on the conduit. Furthermore, the irregular positioning of the rollers 402a-402c allows varying sizes of conduit to be received by the tool 200 for etching.

In some embodiments, the rollers 402a-402c may be made from any suitable material for etching a conduit (e.g., a material that is harder than that of a conduit), such as, but not limited to, steel, annealed metals, heat-treated metals, and/or the like. The rollers may be manufactured by heating a soft steel material for hardening the soft steel material. Examples of the types of conduit that may be etched by the rollers 402a-402c include EMT, polyvinyl chloride (PVC), intermediate metal conduit (IMC), rigid steel metal conduit (RMC), galvanized rigid steel conduit (GRC), plastic, nylon, galvanized steel, and/or the like.

In some embodiments, the tool 200 may further include a vertical level 406. The vertical level 406 may be similar to the horizontal level 202, except for the differences in the orientations of the levels 202 and 406. Accordingly, the tool 200 may incorporate both a horizontal level 202 and a vertical level 406 for conveniently determining whether a horizontal or vertical surface is level or crooked. The bottom of the legs 203 of the tool 200 may provide a stable and flat foundation for obtaining an accurate measure of the levels 202 and 406 at a surface.

In some embodiments, the tool 200 may further include magnets 404 at the bottom of the legs 203. The magnets 404 may produce a strong enough magnetic field for the tool 200 to be securely but removably coupled to other ferromagnetic materials, such as, but not limited to, metal (e.g., metal conduit). The magnets 404 may be made from any suitable ferromagnetic material, such as, but not limited to, iron, cobalt, nickel, rare earth neodymium, ceramic, and/or the like. By positioning the magnets 404 at the bottom of the legs 203, a user of the tool 200 may conveniently attach the tool 200 to a nearby surface while not in use (e.g., onto a conduit that is being worked on). In addition, the tool 200 may be utilized in conjunction with the horizontal level 202 and the vertical level 406 for accurately determining whether a surface (e.g., a surface of a conduit) is level or not. For example, a user may attach the tool 200 to a surface (vertical or horizontal), via the magnets 404, for which the user wishes to determine the level, as the magnets 404 may provide a secure attachment between the surface and the tool 200.

In some embodiments, the tool 200 may include a plurality of markings 408 on the main body 201. The plurality of markings 408 may indicate various diameter sizes of conduit. For example, the tool 200 may include markings that indicate conduit having sizes of ½ inch, ¾ inch, and 1 inch. These markings 408 may signify to a user an angle at which to insert a conduit having the corresponding size through the underside of the main body 201 such that the conduit may be properly aligned with and etched by the rollers 402a-402c. In other embodiments, the markings may include size indicators corresponding to other sizes of conduit, depending on the sizes of conduit that the tool 200 is configured to etch (e.g., 1½ inch conduit, ¼ inch conduit, and so on).

In some embodiments, the tool 200 may include other features that are secondary to the primary features of the tool 200. In some embodiments, the tool 200 may include bottom plates 410a and 410b at the bottom of the legs 203. The bottom plates 410a and 410b may be removable to allow access to the rollers 402a-402c (e.g., for replacement). In addition, bottom plate 410b may be removable for access to the components of the lead ejector 204. The bottom plates 410a and 410b may be attached to the legs 203 by any suitable means, such as, but not limited to, fastener (screw), adhesive, latching, and/or the like. The tool 200 may further include a cap 412 that may be removable for gaining access to a hollow cavity (not shown). The hollow cavity underneath the cap 412 may be utilized to store a plurality of pieces of lead for use in the lead ejector 204. The tool 200 may further include a hole 414 that provides a passage to a piece of lead used in the lead ejector 204. For example, a user may insert a slender object into the hole 414 (e.g., a paper clip) for removal of the piece of lead in the lead ejector 204. The lead may eject from the hole 405 in the bottom plate 410b.

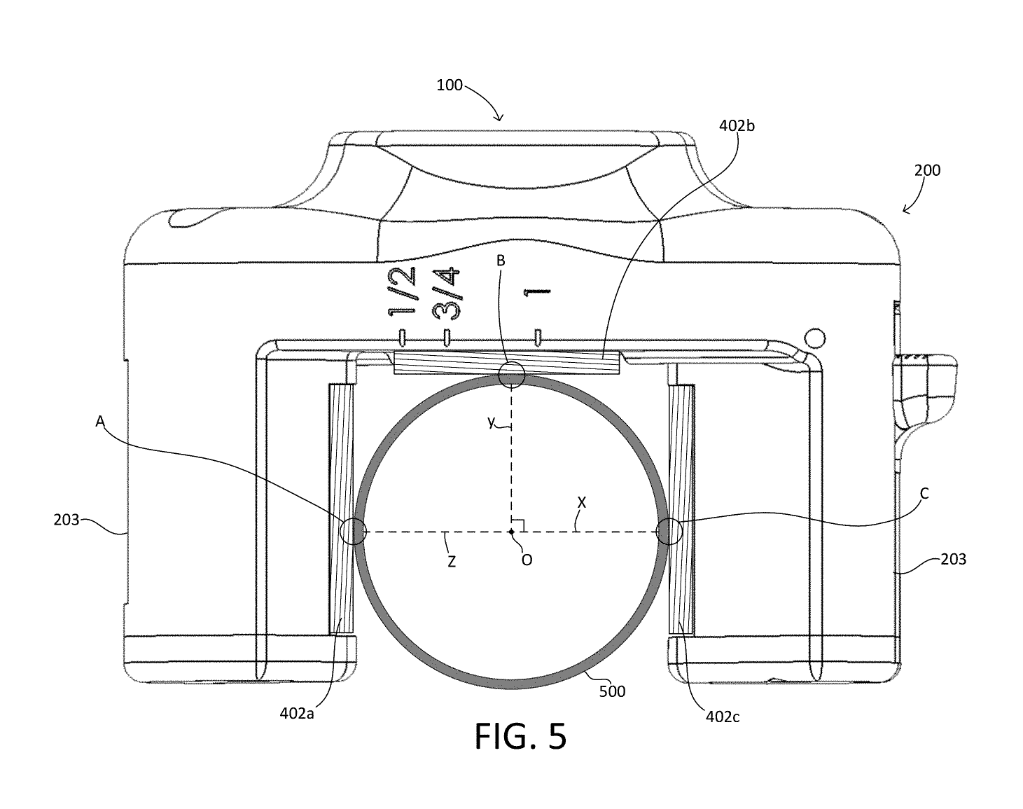

FIG. 5 is a front view of a tool including a plurality of rollers surrounding a conduit according to various embodiments. Features described with respect to the embodiments of FIG. 5 can be employed in other embodiments including, but not limited to, embodiments described with respect to FIGS. 1A-4C. Same reference numbers as those previously illustrated and introduced may correspond to the depiction and description of those reference numbers previously illustrated and previously described.

Referring to FIGS. 1-5, in operation, a conduit 500 is shown as being received by the tool 200 at the underside of the main body 201. The conduit 500 includes a center axis O and a plurality of radii X, Y, and Z, each extending from the center axis O to locations at the circumference of the conduit 500. The conduit 500 is positioned so as to contact each of the rollers 402a-402c. The conduit 500 simultaneously contacts each of the rollers 402a-402c at contact locations A, B, and C. Each of the rollers 402a-402c may be configured to contact the conduit at 90-degree intervals along the circumference of the conduit 500. For example, roller 402a contacts the conduit 500 at contact location A, roller 402b contacts the conduit 500 at contact location B that is 90 degrees spaced from the contact location A along the circumference of the conduit 500 (the 90-degree angle formed by radii Z and Y), and roller 402c contacts the conduit 500 at contact location C that is 90 degrees spaced from the contact location B along the circumference of the conduit 500 (the 90-degree angle formed by radii Y and X). In other words, contact location B may be at the 0-degree location of the circular conduit 500, contact location C may be at the 90-degree location of the circular conduit 500, and contact location A may be at the 270-degree location of the circular conduit 500.

In operation, the length of the conduit (i.e., the length of the conduit extending perpendicular to the radii X, Y, and Z) may be etched or marked by the rollers 402a-402c along three distinct linear paths, each linear path being at 90-degree intervals along the circumference of the conduit 500, as the tool 200 travels via the rollers 402a-402c along the length of the conduit 500. Accordingly, after etching the conduit 500, a user may easily discern the 90-degree locations along the circumference of the conduit 500 so that the user may precisely bend the conduit along one of the 90-degree planes, which may mitigate “dog-legging” of the conduit 500. In such embodiments, a fourth etched linear path at the location opposite the contact location B (i.e., the 180-degree location of the circumference) may not be necessary as a user may easily determine the plane indicated by the fourth linear path based on the other three etched linear paths. However, in some embodiments, the tool 200 may include a fourth roller for etching the fourth linear path.

In some embodiments, each of the linear paths may be lightly etched so as not to disturb the structural integrity of the conduit 500, but discernible enough to see and feel the markings upon closer examination of the conduit 500. In some embodiments, the marks may be more discernable when looking down along the length of the conduit 500, but not as discernible when viewing the conduit at a more perpendicular angle. In other embodiments, the marks may be painted over. In some embodiments, the tool 200 may be secured to a surface via the magnets 404, and the conduit 500 may be fed through the rollers 402a-402c and pushed through the tool 200.

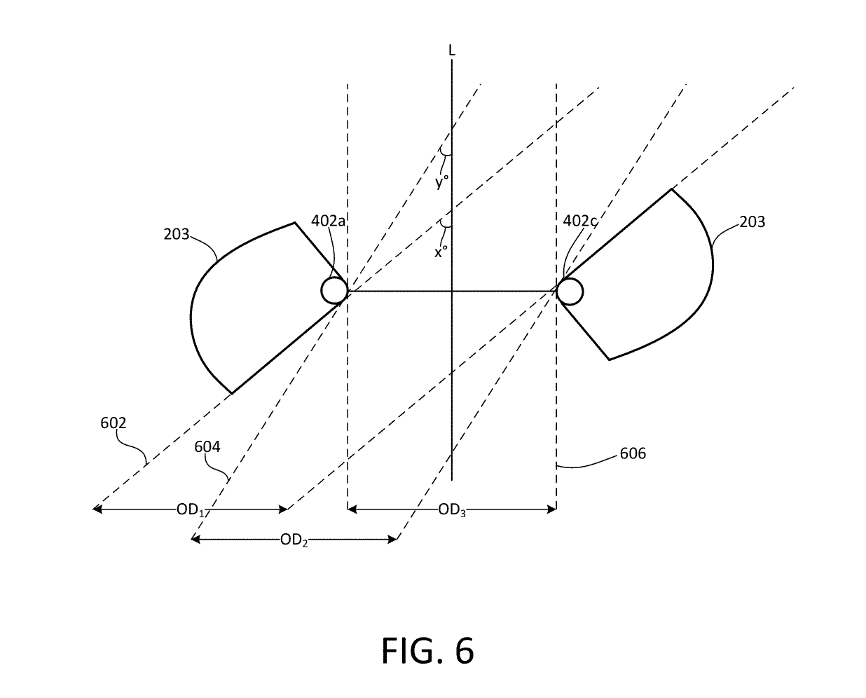

FIG. 6 is a cross-sectional overhead view of a tool including a plurality of rollers surrounding various sized conduits according to various embodiments.

In some embodiments, the tool 200 may be capable of receiving a plurality of different-sized conduits 602, 604, and 606 having outside diameters OD₁, OD₂, and OD₃, respectively. Each of the outside diameters OD₁, OD₂, and OD₃ may have a different value. For example, outside diameter OD₁ may be smaller than outside diameter OD₂, and outside diameter OD₂ may be smaller than outside diameter OD₃. Accordingly, the tool 200 may be configured to receive and etch different-sized conduits by the conduit being tilted with respect to a reference line L such that the tilted conduit contacts each of the plurality of rollers simultaneously and contacts the angled edges of the legs 203. In some embodiments, the larger the outside diameter of the conduit, the smaller the angle of tilt is. For example, the conduit 602 having an outside diameter OD₁ may have an angle X of tilt, and the conduit 604 having an outside diameter OD₂ may have an angle Y of tilt, and the angle X may be larger than the angle Y. In addition, in some embodiments, the conduit 606 having an outside diameter OD₃ may have no angle of tilt. In some embodiments, conduits having outside diameters of ½ inch, ¾ inch, and 1 inch may correspond to different angles of tilt dependent on their size.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, and their equivalents, rather than the embodiments. Various modifications and changes that come within the meaning and range of equivalency of the claims are intended to be within the scope of the invention.

What is claimed is:

1. A conduit reamer component comprising:
a conical body having a first end for receiving a conduit and a second end opposite the first end, the conduit body comprising:
a first circumferential ledge having a first diameter and located in the conical body; and
a second circumferential ledge having a second diameter smaller than the first diameter and located in the conical body, the first circumferential ledge located between the second circumferential ledge and the first end of the conical body.

2. The conduit reamer component of claim 1, wherein the first end of the conical body has a larger diameter than that of the second end of the conical body.

3. The conduit reamer component of claim 1, further comprising:
a slit in the conical body extending longitudinally between the first end and the second end; and
a blade located in the slit and comprising a plurality of slots, each slot located at different distances from a center of the conical body.

4. The conduit reamer of claim 3, wherein the slit crosses the first and second circumferential ledge.

5. The conduit reamer of claim 3, wherein each slot of the blade is configured to receive a conduit having a different diameter.

6. The conduit reamer component of claim 3, wherein the blade comprises a first slot corresponding to the first diameter of the first circumferential ledge and a second slot corresponding to the second diameter of the second circumferential ledge.

7. The conduit reamer component of claim 1, wherein the first circumferential ledge is configured to abut an edge of a conduit having the first diameter and the second circumferential ledge is configured to abut an edge of a conduit having the second diameter.

8. The conduit reamer component of claim 1, wherein the conical body further comprises a third circumferential ledge having a third diameter smaller than the second diameter and located in the conical body, the first and second circumferential ledges located between the third circumferential ledge and the first end of the conical body.

9. The conduit reamer component of claim 8, wherein the third circumferential ledge is configured to abut an edge of a conduit having the third diameter.

10. The conduit reamer component of claim 1, wherein the conduit reamer component is configured to fit into a plurality of different tools.

11. A method of manufacturing a conduit reamer component, the method comprising:
providing a conical body having a first end for receiving a conduit and a second end opposite the first end;
molding a first circumferential ledge having a first diameter and located in the conical body; and
molding a second circumferential ledge having a second diameter smaller than the first diameter and located in the conical body, the first circumferential ledge located between the second circumferential ledge and the first end of the conical body.

12. The method of claim 11, further comprising:
forming a slit in the conical body extending longitudinally between the first end and the second end; and
providing a blade located in the slit and comprising a plurality of slots, each slot located at different distances from a center of the conical body.

13. The method of claim 12, wherein the slit crosses the first and second circumferential ledge.

14. The method of claim 12, wherein the blade comprises a first slot corresponding to the first diameter of the first circumferential ledge and a second slot corresponding to the second diameter of the second circumferential ledge.

15. The method of claim 11, wherein the conduit reamer component is configured to fit into a plurality of different tools.

16. A tool for receiving and marking a conduit comprising:
a plurality of rollers configured to contact a conduit a 90-degree intervals along a circumference of the conduit, each of the rollers configured to etch a length of the conduit.

17. The tool of claim 16, wherein the plurality of rollers comprises:
a first roller configured to etch a length of a conduit along a first linear path along the length of the conduit; and
a second roller configured to etch the length of the conduit along a second linear path along the length of the conduit, the second linear path being spaced 90 degrees from the first linear path along a circumference of the conduit.

18. The tool of claim 17, wherein the plurality of rollers further comprises a third roller configured to etch the length of the conduit along a third linear path along the length of the conduit, the third linear path being spaced 90 degrees from the second linear path along the circumference of the conduit.

19. The tool of claim 16, wherein each of the plurality of rollers is configured to contact the conduit simultaneously when the conduit is tilted at a first angle within the tool, and wherein each of the plurality of rollers is further configured to contact a second conduit, having a size different from that of the conduit, simultaneously when the second conduit is tilted at a second angle different from the first angle within the tool.

20. The tool of claim 16, further comprising a cavity for storing a plurality of pieces of lead, each of the pieces of lead to be used with a lead ejector component in the tool.
